(19) United States
(12) Patent Application Publication
(10) Pub. No.: US 2020/0205428 A1
(43) Pub. Date: Jul. 2, 2020

(54) MEAT TREATMENT

(71) Applicant: Purac Biochem B.V., Gorinchem (NL)

(72) Inventors: Saurabh KUMAR, Gorinchem (NL); Jacobus Johannes Adriana M VERHEEZEN, Gorinchem (NL); Prita PRITAWARDANI, Gorinchem (NL)

(21) Appl. No.: 16/816,040

(22) Filed: Mar. 11, 2020

Related U.S. Application Data
(63) Continuation of application No. PCT/NL2018/050592, filed on Sep. 11, 2018.

(30) Foreign Application Priority Data
Sep. 12, 2017 (NL) PCT/NL2017/050593

(51) Int. Cl. A23B 4/20; A23D 7/01; A23L 13/40; A23L 13/00; A23D 7/005

(52) U.S. Cl. CPC A23B 4/20; A23D 7/011; A23L 13/43; A23L 13/03; A23V 2250/02; A23V 2002/00; A23V 2200/242; A23V 2200/10; A23D 7/0053

(57) ABSTRACT

The present invention relates to microbial safety of meat products. In particular new additives are provided for effective reduction of pathogenic bacteria, such as Shiga toxin producing Escherichia coli (STEC), on or in meat products. The present inventors found that a combination of a nonionic surfactant and organic acid is particularly effective in the reduction of these and other pathogenic bacteria in meat products. The addition of a thickening agent was found to further enhance the effectiveness of the compositions in eliminating these pathogenic bacteria. The present invention provides these meat preservation compositions, the methods of treating meat with these compositions, the related uses of these compositions, as well as the meat products accordingly obtained.

### CROSS-REFERENCE TO RELATED APPLICATIONS

This application is a continuation of International Application No. PCT/NL2018/050592, filed Sep. 11, 2018, which claims the benefit of and priority to International Application No. PCT/NL2017/050593, filed Sep. 12, 2017, both of which are hereby incorporated by reference herein in their entireties.

### FIELD OF THE INVENTION

The present invention relates to microbial safety and spoilage of meat products. New procedures and additives are provided for reduction of bacteria in or on meat products.

### BACKGROUND OF THE INVENTION

Meat spoilage and rancidity is typically caused by unwanted growth of certain aerobic and anaerobic bacteria that contact the meat during processing. The growth of these undesired bacteria on meat affects the shelf life thereof.

Growth of spoilage bacteria, such as Pseudomonades, Lactobacillus and Coliforms, creates undesired odors and/or taste due to bacterial production of certain esters, hydrogen sulfide, nitrogenous compounds, propionic acid, formic acid, as well as other undesirable components. Some bacteria also act to discolor the surface of the meat. Moreover, when meat packaged in permeable plastic packages spoils, the packaging often inflates due to the generation of gas produced by spoilage bacteria.

Contamination of meat with pathogenic bacteria is an even greater concern since such bacteria, or toxins produced by such bacteria, can cause (severe) illness in humans and animals that consume such meat. In the meat processing industry, many types of bacteria are known to cause food poisoning, including: Shiga toxin producing Escherichia coli, Salmonella, Listeria, Staphylococcus, Streptococcus, Bacillus anthraces, Balantidium coli, Campylobacter coli, Campylobacter jejune, Francisella tularensis, Sarcocystis, Taenia saginata, Taenia solium, Toxoplasma gondil, Trichinella spiralis, Yersinia enterocolinea, Yersinia pseudotuberculosis, Brucella, Chlamydia petechia, Leptospira and Clostridium. Numerous outbreaks of Shiga toxin producing E. coli (STEC) infections have been associated with beef products. STEC was declared an adulterant in non-intact beef by the USDA in 1994. The infectious dose of STEC is rather low, while infection can cause severe symptoms and in some case can prove lethal. Hence, the bacteriocidal control of these pathogens is critical.

Each group of pathogenic bacteria proliferates under different conditions, any or all of which may be encountered in meat processing. For example, Listeria is generally found in cool, damp environments such as coolers and meat processing areas and is even able to proliferate in and compromise the safety of vacuum packaged meat.

The opportunity for pathogenic bacteria to contact fresh meat begins when an animal is initially presented for processing and extends up until the time the meat product is consumed. Bacterial contamination of fresh meat is a thus particular concern during the slaughtering and initial processing of animals due to the contaminated state of the animal when it enters the facility. The time between the initial opportunity for bacterial contact with meat products and the ultimate consumption of such products by consumers, allows for the proliferation of undesired spoilage and pathogenic bacteria. Although these bacteria are destroyed by proper cooking, illnesses may result from improper handling (e.g. resulting in cross-contamination) and/or improper cooking. Good management practices during pre-harvest and processing can reduce the prevalence of foodborne pathogens associated with fresh meat products.

Skeletal muscle from healthy animals can generally be considered sterile prior to slaughter. Hides are a primary source for bacteria contamination on carcasses that could carry contamination through the whole production process if not addressed and controlled.

Several intervention options may be utilized to decontaminate the hide before it is removed from the carcass to prevent cross contamination on the sterile exterior of the hide-off carcass. Some slaughterers/processors will use a hot water wash designed to rinse and scrub dirt and fecal material from the exterior of the hide along with some thermal destruction of bacteria. Chemicals, such as sodium hydroxide, trisodium phosphate, chlorine, or acidified chlorine may also be used to decontaminate hides. Once the hide is clean, the process of removing the hide begins.

Hide removal is the most time consuming and intricate step in the slaughter process as there are multiple steps conducted to prevent contamination of the internal carcass. Removal begins with a knife used at the hocks and midlines, and knife sterilization is key to preventing cross-contamination. Steps such as placing paper on the inside flaps of hides to prevent them from swinging and touching the outside surface of clean carcasses are small steps that can have a large impact in preventing contamination to the carcasses. The initial opening of the hide is often trimmed to remove the exterior pieces of tissue that may have come in contact with the hide. Steam vacuuming is also used to decontaminate the limb removal sites at the hocks and shanks. Organic acids (such as lactic acid or citric acid) may be applied to the midline of the ventral (under) side of the beef carcasses before the peritoneal cavity (internal cavity) of the carcass is opened for evisceration (removal of viscera/organs).

Many processors have pre-evisceration food safety interventions in place before the removal of the visceral organs takes place. This often times includes an organic acid, halogen or peroxyacetic acid spray and/or a hot water wash which helps to ensure decontamination of bacteria that may have occurred during the hide removal and before the evisceration process. Knives are sterilized between processing each carcass to avoid cross contamination. Typically beef carcasses undergo tested pathogen reduction interventions such as hot water pasteurization, steam pasteurization or oxidizing biocide wash followed by treatment with an antimicrobial acid spray before entering the cooler for chilling. Carcasses are chilled after harvest, typically via spray chilling methods. In the carcass coolers for approximately 24 hours following processing, carcasses are chilled with refrigeration and cold water to help drop the temperature of the carcasses rapidly to prevent growth of microorganisms. The water helps in the chilling process and also can serve as an antimicrobial intervention via washing which may include the addition of low concentration acids or oxidizers to hinder bacteria growth.

After the carcasses are properly chilled, the meat fabrication process begins, during which carcasses are disassembled and processed first into primal and subprimal cuts and then saleable products (i.e. roast, steaks, etc.). Additional antimicrobials such as organic acids and/or oxidizing biocides are applied as sprays to reduce bacteria counts prior to product packaging. Meat may also be further modified to either extend its shelf life or change the taste (e.g. by smoking, curing, or adding salt) to produce so-called ‘processed meat’. These processes are carried out on sanitary surfaces with sterilized equipment to further prevent microbial contamination before the products are packaged.

Consumers' demands for products with a ‘fresh-like’ quality are driving processors to develop new procedures and additives for maximal inhibition or prevention of bacterial outgrowth with minimal impact on the visual and/or organoleptic qualities of the meat. There is a particular desire to accomplish this using additives that the consumer perceives as ‘natural’. Any ingredient used should not negatively interfere with the visual and/or sensorial properties of the products, i.e. when used at effective levels.

WO2008144024 discloses disinfectant solutions comprising an acid solution such as lactic acid solution, an antimicrobial metal ion source, at least one wetting surfactant and optionally a non-ionic surfactant. Inherent to the use of these solutions is the need to add metal ions which include silver and copper.

It is the objective of the present invention to provide new and improved compositions and methods of treating meat.

### SUMMARY OF THE INVENTION

The present inventors surprisingly found that the objective of the present invention could be realized with a combination of a nonionic surfactant, said nonionic surfactant being selected from the group consisting of polyglycerol fatty acid esters, with an organic acid. Such combinations are effective in reducing bacterial counts in or on fresh/raw meat samples. The combinations, more in particular, proved to be effective at levels that do not result in significant (negative) effects on the flavor, color and/or taste of the products.

As will be illustrated in the appending examples, the present inventors, found that the application of a meat treatment composition comprising a combination of the nonionic surfactant as defined herein and an organic acid reduced bacterial counts in or on fresh meat products, under various conditions, compared to untreated control samples and compared to control samples treated with lactic acid.

The inventors believe that the combinations of the present invention are particularly suited for meat treatment due to the combined effects of the organic acid component and the surface active agent. When magnified, the meat and fat surfaces of animal carcasses can be shown to have a rough, undulating texture with peaks and crevices where bacterial cells may “hide” from exposure to surface sprays. Without wishing to be bound by any particular theory, it is hypothesized that the combinations of the present invention, increase the probability of contact between the bacteria and the formula as the surfactant reduces the surface tension of each spray drop of solution so as to increase the spreadability and thus the likelihood that the formula flows to the fat and lean crevices that might otherwise protect bacteria.

The present invention provides the meat treatment compositions that can be used to extend the shelf-life of meat products, in particular to reduce bacteria counts. The use of these meat treatment compositions and methods of treating meat products are also provided, as are the meat products obtained accordingly.

These and other aspects of the invention will be described and illustrated in more detail in the following sections.

### DETAILED DESCRIPTION OF THE INVENTION

A first aspect of this invention provides a meat treatment composition comprising (i) a non-ionic surfactant, selected from the group of polyglycerol fatty acid esters and (ii) an organic acid component.

The non-ionic surfactants of the present invention constitute a particular class of substances, generally known/recognized by those skilled in the art. Polyglycerol fatty acid esters are commonly designated as ‘E475’ (according the EU numbering scheme of permitted food additive). Polyglycerol fatty acid esters are emulsifiers. Chemically, they can be defined as mixed partial esters formed by reacting polymerized glycerols with edible fats, oils, or fatty acids. Minor amounts of mono-, di-, and triglycerides, free glycerol and polyglycerols, free fatty acids, and sodium salts of fatty acids may be present. The degree of polymerization varies, and is specified by a pre-fix (such as monno-, di-, tri-, tetra-, etc) that relates to the average number of glycerol residues per polyglycerol molecule. A specified polyglycerol consists of a distribution of molecular species characteristic of its nominal degree of polymerization. The proportions as well as the nature of the fats or fatty acids to be reacted with the polyglycerols can be varied to produce distinct polyglycerol fatty acid esters.

In a preferred embodiment of the invention, the non-ionic surfactant is selected from the group consisting of the mono- and di- esters of C₁₄-C₂₂ fatty acids, preferably C₁₆-C₂₀ fatty acids, more preferably C₁₈ fatty acids, most preferably stearic acid or oleic acid; and glycerin polymers, preferably glycerin polymers having an average of 6-12 glycerin units. In a preferred embodiment of the invention, the non-ionic surfactant is selected from the group consisting of the mono- and di- esters of oleic acid and glycerin polymers having an average of 8, 9 or 10 glycerin units. Most preferably the non-ionic surfactant is a mono/diester of oleic acid and a glycerin polymer containing an average of ten glycerin units, which may be referred to as decaglycerol mono/dioleate. This product is commercially available under the brand/trade name Caprol PGE 860.

The meat treatment composition also comprises (ii) an organic acid component, selected from the group consisting of C₂-C₈ monocarboxylic acids, lactic acid, citric acid and salts thereof, most preferably acetic acid, lactic acid, propionic acid. In accordance with the invention, the acid can be partially neutralized, meaning that the meat treatment composition comprises a combination of the organic acid and one or more salts of the organic acid. Whenever, in this document, reference is made to the organic acid component this term encompasses the organic acid as well as any salt thereof as present in the meat treatment composition. In one preferred embodiment of the invention, the meat treatment composition comprises an acetate component selected from acetic acid and mixtures of acetic acid and acetic acid salts, preferably in the form of a non-neutralized or partially neutralized vinegar.

In another preferred embodiment the preservative combination comprises a lactate component selected from lactic acid and mixtures of lactic acid and lactic acid salts, mixtures of lactic acid with sodium lactate, calcium lactate and/or potassium lactate, preferably in the form of a fermentation product, such as a non-neutralized or partially neutralized lactic acid ferment. In another preferred embodiment the preservative combination comprises a propionate component, selected from propionic acid and mixtures of propionic acid and propionic acid salts, preferably mixtures of propionic acid with sodium propionate, calcium propionate and/or, potassium propionate, preferably in the form of a fermentation product, such as a non-neutralized or partially neutralized propionic acid ferment.

The term vinegar is used to denote the liquid obtained by the acetous fermentation of an alcoholic liquid, containing at least 4 grams of acetic acid per 100 ml, in particular a vinegar that can be declared ‘natural’, e.g. in terms of the FDA guidelines. According to said guidelines “natural” means minimally processed and containing no synthetic ingredients or processing aids (cf. Food Labeling: Nutrient Content Claims General Principles, Petitions, Definitions of Terms, 56 Fed. Reg. at 60,466). In a preferred embodiment the meat treatment composition comprises a non-neutralized, partly neutralized or completely neutralized vinegar selected from the group consisting of white vinegar, brandy vinegar, alcoholic vinegar, balsamic vinegar, wine vinegar, malt vinegar, beer vinegar, potato vinegar, rice vinegar, apple vinegar, cherry vinegar, and cane vinegar. In a particularly preferred embodiment of the invention, the vinegar is cane vinegar. In a preferred embodiment of the invention, the acetic acid content of the vinegar is at least 5% (w/w), more preferably at least 7.5% (w/w), even more preferably at least 10% (w/w). It is also possible to make use of vinegar that has been pre-concentrated to a certain extent. Such products are commercially available and typically have an acetic acid content between 20 and 30% (w/w). In a preferred embodiment of the invention, the acetic acid content of the vinegar is at least 20% (w/w), more preferably at least 25% (w/w), e.g. about 29 or 30% (w/w). A common measure for indicating the acetic acid content of vinegar is the grain strength. The grain strength is the acetic acid content expressed in g/l, so 50 grain vinegar is about 5% (w/w) acetic acid. As will be appreciated by those skilled in the art, it is preferred that the vinegar is at least 200 grain, more preferably at least 250 grain. Often, commercial food-grade vinegars are offered at 200 grain and 300 grain. In one preferred embodiment of the invention, a 300 grain vinegar is used.

Fermentation products, in accordance with the invention, typically are crude or partially purified/clarified ferments. Such fermentation products have favorable organoleptic profiles, which contribute positively to the taste and flavour characteristics of food products to which they are added. Moreover, such fermentation products will provide additional benefits with regard to labeling and regulatory aspects. Fermentation products, in accordance with the invention are obtainable by fermentation of a fermentable substrate with a suitable microorganism, in this case a lactic acid and/or propionic acid producing microorganism, resulting in a composition typically comprising, besides the lactic acid or propionic acid component, traces of the fermentable substrate, other substances produced by the microorganism, and traces of the microorganism itself, e.g. cellular debris and/or cellular components. The lactic acid and/or propionic acid producing micro-organisms may also produce other preservative compounds such as nisin or other bacteriocins, acetic acid, succinic acid, etc. As such, a liquid fermentation product is distinguishable from e.g. highly purified products. The term however does not exclude products which have been subjected to some form of purification/clarification and/or concentration.

In one embodiment, the fermentation product is the crude product obtainable by fermentation of a fermentable substrate with a lactic acid or propionic acid producing microorganism followed by separating supernatant from (wet) biomass and other solid particles.

In one embodiment, the fermentation product is the supernatant obtainable by fermentation of a fermentable substrate with a lactic acid or propionic acid producing microorganism followed by separating supernatant from (wet) biomass and other solid particles.

In one embodiment of the invention, the fermentation product is a concentrated supernatant obtainable by fermentation of a fermentable substrate with a lactic acid or propionic acid producing microorganism followed by separating supernatant from (wet) biomass and other solid particles and concentrating the supernatant.

In one embodiment of the invention the fermentation product is a partially purified and optionally concentrated supernatant obtainable by fermentation of a fermentable substrate with a lactic acid or propionic acid producing microorganism followed by separation of supernatant from (wet) biomass and other solid particles, purification of the supernatant and, optionally, concentration of the supernatant, with the proviso that the purification does not result in a level of the lactate component or propionate component of more than 97 wt. % on a dry solids weight basis, preferably it does not result in a level of the lactate component or propionate component of more than 96 wt. % on a dry solids weight basis, most preferably it does not result in a level of the lactate component or propionate component of more than 95 wt. % on a dry solids weight basis.

As will be clear to those skilled in the art, the fermentation product comprises other dispersed or dissolved solids besides the lactate or propionate component. Typical examples of such other dispersed or dissolved solids include sugars, such as lactose, glucose and sucrose; other organic acids and/or salts thereof, such as citric acid, pyruvic acid, malic acid, succinic acid, formic acid and acetic acid; nitrogen containing substances, such as amino acids, peptides and proteins; nucleic acid components such as DNA and RNA fragments, nucleotides and nucleosides; cell membrane phospholipids; vitamins; trace elements; and pigments. In a preferred embodiment of the invention, the liquid fermentation product comprises at least one, at least two, at least three, at least four or at least five components selected from the group consisting of lactose, glucose, sucrose, citric acid and salts thereof, pyruvic acid and salts thereof, malic acid and salts thereof, succinic acid and salts thereof, formic acid and salts thereof, acetic acid and salts thereof, amino acids, peptides and proteins. In a preferred embodiment of the invention the liquid fermentation product comprises at least 0.5 wt. % on a dry solids weight basis, preferably at least 1 wt. %, more preferably at least 2 wt. % of one or more components selected from the group consisting of lactose, glucose, sucrose, citric acid and salts thereof, pyruvic acid and salts thereof, malic acid and salts thereof, succinic acid and salts thereof, formic acid and salts thereof, acetic acid and salts thereof, amino acids, peptides and proteins.

In a preferred embodiment the meat treatment composition also comprises (iii) a thickening agent. The thickener increases the viscosity resulting in longer residence of the spray on the meat surface as gravity acts upon the liquid causing it to run-off the meat. In accordance with the invention, the thickening agent can be any material effective in providing gelling, viscosifying, or thickening properties or which otherwise provide structure to aqueous compositions. These thickening agents may include gelling agents, polymeric or nonpolymeric agents, inorganic thickening agents, or viscosifying agents. The thickening agents may include organic solids, silicone solids, crystalline or other gellants, inorganic particulates such as clays or silicas, or combinations thereof. Non-limiting examples of suitable gelling agents include fatty acid gellants, salts of fatty acids, hydroxyl acids, hydroxyl acid gellants, esters and amides of fatty acid or hydroxyl fatty acid gellants, cholesterolic materials, dibenzylidene alditols, lanolinolic materials, fatty alcohols, triglycerides, sucrose esters such as SEFA behenate, inorganic materials such as clays or silicas, other amide or polyamide gellants, and mixtures thereof. Particularly preferred thickening agents are selected from the group consisting of natural polymers and derivatives of natural polymers, such as natural gums, cellulose, cellulose derivatives, pectins, gelatins, carrageenan, alginates, dextran, starch, chitosan, etc. Particularly preferred thickening agents in accordance with the invention include hydroxypropyl methylcellulose and polysaccharides produced by micro-organsims, such as xanthan gum, carrageenan and alginates. In a particularly preferred embodiment of the invention, the thickening agent is xanthan gum.

In an embodiment of the invention, a meat treatment composition as defined herein is provided, wherein the organic acid and the nonionic surfactant are present in a weight ratio within the range of 300/1-10/1, preferably in a weight ratio within the range of 250/1-20/1, more preferably in a weight ratio within the range of 200/1-40/1.

In a further embodiment of the invention, a meat treatment composition as defined herein is provided, wherein the organic acid and the optional thickening agent are present in a weight ratio within the range of 200/1-20/1, preferably in a weight ratio within the range of 150/1-40/1, more preferably in a weight ratio within the range of 100/1-50/1.

A preferred embodiment of the invention concerns a meat treatment composition as defined herein before containing (i) the nonionic surfactant, (ii) an acid component, preferably in the form of a fermentation product and (iii) the optional a thickening agent. As will be understood, such a meat treatment composition typically is the product obtained by mixing the nonionic surfactant, the acid component, preferably a fermentation product containing the acid component and optionally a thickening agent. In certain embodiments of the invention the meat treatment composition further comprises a carrier system, comprising one or more solid or liquid carrier materials and optionally one or more additives.

In a particularly preferred embodiment of the invention, a liquid meat treatment composition is provided comprising a solution or dispersion of the above defined components in a liquid carrier, preferably water. In a particularly preferred embodiment of the invention a liquid meat treatment composition is produced by combining the above defined components with water or an aqueous solvent and optional further additives. Such liquid meat treatment compositions are suitable for direct application, although embodiments are envisaged wherein such compositions are further diluted before applying them.

In an embodiment of the invention, a meat treatment composition as defined herein is provided, wherein the composition is formulated as a concentrate. The concentrate typically comprises the non-ionic surfactant, the organic acid component and optionally the thickening agent in combination with water. Such concentrates are typically intended for dilution with water before use. Such concentrated slurries will typically comprise the non-ionic surfactant, the organic acid component and optionally the thickening agent in a combined amount of at least 20 wt. %, based on the total weight of the concentrated slurry, more preferably in a combined amount of at least 40 wt. %, most preferably in a combined amount of at least 50 wt. %. In certain embodiments of the invention, the meat treatment composition is provided as a concentrate comprising the nonionic surfactant at a level of 0.2-2.5 wt. %, more preferably 0.25-2.0 wt. %, based on the total weight of the concentrate. In certain embodiments of the invention the meat treatment composition is provided as a concentrate comprising the organic acid component at a level of 20-95 wt. %, more preferably 40-90 wt. %, based on the total weight of the concentrate. In certain embodiments of the invention, the meat treatment composition is provided as a concentrate comprising the thickening agent at a level of 0.2-2.5 wt. %, more preferably 0.25-2.0 wt. %, based on the total weight of the concentrate.

In an embodiment of the invention, a meat treatment composition as defined herein is provided, wherein the composition is formulated as a ready-to-use liquid. This liquid typically comprises the non-ionic surfactant, the organic acid component and optionally the thickening agent in combination with water. Such liquids will typically comprise the non-ionic surfactant, the organic acid component and the optional thickening agent in a combined amount of at least 0.5 wt. %, based on the total weight of the liquid, preferably in a combined amount of 1-20 wt. %, more preferably in a combined amount of 1.5-10 wt. %, most preferably in a combined amount of 2.5-7.5 wt. %. In an embodiment of the invention, this ready-to-use liquid comprises the nonionic surfactant in an amount within the range of 0.01-0.5 wt. %, preferably in an amount within the range of 0.02-0.25 wt. %, most preferably in an amount within the range of 0.05-0.1 wt. %, based on the total weight of the liquid. In an embodiment of the invention, the ready-to use liquid comprises the organic acid component in an amount within the range of 1-20 wt. % more preferably in an amount within the range of 1.5-10 wt. %, most preferably in an amount within the range of 2.5-7.5 wt. %, based on the total weight of the liquid. In an embodiment of the invention, this ready-to-use liquid comprises the thickening agent in an amount within the range of 0.01-0.5 wt. %, preferably in an amount within the range of 0.02-0.25 wt. %, most preferably in an amount within the range of 0.05-0.1 wt. %, based on the total weight of the liquid.

In an embodiment of the invention, the ready-to-use liquid has a pH value of less than 6, preferably a pH value within the range of 1.5-5, more preferably within the range of 2-4.

In accordance with an embodiment of this invention, the meat treatment composition as defined herein further comprises (iv) an agent that stabilizes the concentrate and/or ready-to-use liquid. Especially with a view to storage stability of the concentrate forms of the present meat treatment compositions, the addition of a (iv) dispersing agent that is capable of keeping all the components (homogenously) dispersed in the acid, may be advantageous. In an embodiment of the invention the meat treatment composition comprises (iv) a dispersing agent selected from the group consisting of glycerin fatty acid esters (monoglycerides), acetic acid esters of monoglycerides, lactic acid esters of monoglycerides, citric acid esters of monoglycerides, succinic acid esters of monoglycerides, diacetyl tartaric acid esters of monoglycerides, polyglycerol esters of fatty acids, polyglycerol polyricinoleate, sorbitan esters of fatty acids, propylene glycol esters of fatty acids, sucrose esters of fatty acids, calcium stearoyl di lactate and lecithin (including enzyme digested/treated lecithins). In certain embodiments of the invention the meat treatment composition is provided as a concentrate comprising the dispersing agent at a level of 0.2-2.5 wt. %, more preferably 0.25-2.0 wt. %, based on the total weight of the concentrate. In certain embodiments of the invention the meat treatment composition is provided as a ready-to-use liquid comprising the dispersing agent in an amount within the range of 0.01-0.5 wt. %, preferably in an amount within the range of 0.02-0.25 wt. %, most preferably in an amount within the range of 0.05-0.1 wt. %, based on the total weight of the liquid.

In accordance with an embodiment of the invention, the meat treatment composition does not contain substantial amounts of components other than (i) the nonionic surfactant, (ii) the acid component, (iii) the optional thickening agent and carrier materials such as water. In an embodiment of the invention the meat treatment composition essentially consists of the combination of (i) the nonionic surfactant, (ii) the acid component, (iii) the optional thickening agent and optional carrier materials. In an embodiment of the invention, the meat treatment composition is substantially free of other preservative agents. In an embodiment of the invention, the meat treatment composition is entirely free of other preservative agents. In an embodiment of the invention, the meat treatment composition comprises less than 10 ppm, less than 1 ppm or less than 0.1 ppm of antimicrobial metal ions selected from silver ions, copper ions and zinc ions. In an embodiment of the invention, the meat treatment composition is substantially free of antimicrobial metal ions selected from silver ions, copper ions and zinc ions. In an embodiment of the invention, the meat treatment composition is entirely free of antimicrobial metal ions selected from silver ions, copper ions and zinc ions.

It is envisaged that compositions according to the present invention can also suitably be provided in a kit-of-parts wherein one or more of (i) the nonionic surfactant, (ii) the acid component and (iii) the optional thickening agent is packaged separately from the other.

Hence, in an embodiment of this invention, a kit of parts is provided comprising two or more separate containers, wherein a first container holds a quantity of (ii) the organic acid component, typically as a liquid, optionally in combination with a quantity of one of (i) the non-ionic surfactant and (iii) the thickening agent and wherein a second container holds a quantity of one or both of the (i) the non-ionic surfactant and (iii) the thickening agent. In an embodiment of this invention, a kit of parts is provided comprising two or more separate containers wherein a first container holds a quantity of (i) the non-ionic surfactant and a second container holds a quantity of (ii) the organic acid component and (iii) the optional thickening agent. In an embodiment of this invention, a kit of parts is provided comprising two or more separate containers wherein a first container holds a quantity of (i) the non-ionic surfactant and (ii) the organic acid component and a second container holds a quantity of (iii) the thickening agent. In an embodiment of this invention, a kit of parts is provided comprising at least three containers, wherein a first container holds a quantity of (i) the non-ionic surfactant, a second container holds a quantity of (ii) the organic acid component, and a third container holds a quantity of the thickening agent.

The compositions held in the various containers may be in liquid or dry form, depending on, amongst others, the suitability of the respective component or mixture of components to be dried, stored in dry form and/or to be re-dispersed for use, as the person skilled in the art can readily determine. If components or mixtures of components are provided in liquid form, e.g. in the form of an aqueous dispersion of solution, they will typically be at concentrations that allow for the production of a ready-to-use liquid as defined herein before by simple mixing of the components, i.e. without having to remove water or any other solvent. In preferred embodiments of the invention, components or mixtures of components provided in liquid form, will preferably take the form of a concentrate so that use of the kit-of-parts will entail the combining of the components held in the various containers and the addition of a quantity of (tap) water.

In a particularly preferred embodiment, the kit of parts further comprises a label or leaflet with instructions for use, said use comprising combining the components held in the containers included in the kit-of-parts, optionally adding a quantity of (tap) water, and applying the liquid accordingly obtained to an animal meat surface that is to be treated in accordance with the invention.

A further aspect of the invention concerns a method of treating a meat product, said method comprising contacting the meat product with (i) a nonionic surfactant, as defined herein before and (ii) organic acid. In a preferred embodiment a method of treating a meat product is provided, said method comprising contacting the meat product, in particular a surface thereof, with the meat treatment composition as described herein before.

In a preferred embodiment of the invention, the method of treating a meat product described herein comprises contacting the meat product with the meat treatment composition as described herein, by spraying, dipping or submersion.

In another preferred embodiment of the invention, the method of treating a meat product described herein comprises contacting the meat product with the meat treatment composition as described herein, wherein the meat treatment composition has a temperature of 0-80° C., preferably 10-60° C., most preferably 20-55° C.

In certain embodiments of the invention, it is preferred that following application of the meat treatment composition to the surface of the meat product, said surface is subjected to treatment resulting in complete or partial removal of the preservative components from the surface of the meat product. Hence, in another embodiment of the invention, the method of treating a meat product comprises the consecutive steps of:
(a) contacting the meat product, in particular a surface thereof, with water, typically with water having a temperature within the range of 0-80° C., preferably 10-60° C., most preferably 20-55° C.;
(b) contacting the meat product, in particular said surface thereof, with the meat treatment composition of the present invention, wherein the meat treatment composition preferably has a temperature of 0-80° C., preferably 10-60° C., most preferably 20-55° C.;
(c) rinsing the meat product, in particular said surface thereof, with water.

In accordance with the invention, the meat product typically is at a temperature of -40-70° C., preferably -20-60° C., most preferably 0-45° C., when the meat treatment is carried out.

As discussed herein, this treatment is effective to induce a bacteriocidal effect in respect of species of bacteria that can contaminate the meat in the slaughtering process. In accordance with the invention, the ‘bacteriocidal effect’ preferably refers to the killing of bacteria on a meat surface and/or to reduce the number of (viable) bacteria on a meat surface.

In a preferred embodiment of the invention the bacteriocidal effect is in respect of pathogenic species of bacteria. In another preferred embodiment of the invention the bacteriocidal effect is in respect of spore-forming species of bacteria. In another preferred embodiment the bacteriocidal effect is in respect of one or more species of bacteria selected from the group of mesophilic bacteria, psychrotrophic bacteria and psychrophilic bacteria. In another preferred embodiment of the invention the bacteriocidal effect is in respect of aerobic species of bacteria. In another preferred embodiment of the invention, the bacteriocidal effect is in respect of one or more species of bacteria selected from the group consisting of Enterobacteriaceae, lactic acid bacteria, Clostridium spp., Salmonella spp., Listeria spp., Bacillus spp., Staphylococcus spp., E. coli, Streptococcus spp, Lactobacillus spp, Balantidium coli, Campylobacter coli, Campylobacter jejune, Francisella tularensis, Sarcocystis, Taenia saginata, Taenia solium, Toxoplasma gondil, Trichinella spiralis, Yersinia enterocolinea, Yersinia pseudotuberculosis, Brucella, Chlamydia petechia and Leptospira, in particular from Escherichia coli, Clostridium botulinum, Clostridium perfringens, Staphylococcus aureus, Listeria monocytogenes and/or Bacillus cereus. In a preferred embodiment of the invention the bacteriocidal effect is in respect of one or more species of bacteria selected from the group consisting of Escherichia coli, especially Shiga toxin producing Escherichia coli (STEC), such as O157:H7, O26, O45, O103, O111, O121, and O145.

Hence, in an embodiment, the method of the present invention is performed with the aim of reducing microbial counts on an animal meat surface.

As will be understood by those skilled in the art, the meat treatment compositions are applied at an amount sufficient to achieve the above described bacteriocidal effects. In the context of the present invention, a treatment is considered bacteriocidal if an effect can be shown in direct comparison with a suitable control, typically an otherwise similar meat product that has not undergone the treatment of the present invention.

In one preferred embodiment the method comprises applying the meat treatment composition in a quantity (expressed as volume of the composition per area of meat surface) within the range of 0.001-50 ml/cm², preferably 0.005-5 ml/cm², more preferably 0.01-1 ml/cm².

In one preferred embodiment the method comprises applying the non-ionic surfactant at a level (expressed in grams of the composition per area of meat surface) within the range of 0.005-250 g/m², preferably within the range of 0.01-50 g/m², preferably within the range of 0.025-10 g/m², preferably within the range of 0.05-5 g/m².

In one preferred embodiment the method comprises applying the organic acid component, as defined herein before, at a level within the range of 0.1-25000 g/m², preferably 0.5-5000 g/m², more preferably 1-1000 g/m².

In one preferred embodiment the method comprises applying the thickener at a level within the range of 0.005-250 g/m², preferably within the range of 0.01-50 g/m², preferably within the range of 0.025-10 g/m², preferably within the range of 0.05-5 g/m².

As noted herein before, the present meat treatment composition is particularly suited, and intended, for application in surface treatment of meat.

Historically, the term “meat” has typically been used to refer to the muscular flesh of animal species living on land, i.e. to the exclusion of aquatic and avian animal species. The term is often considered to additionally refer to other edible tissues, such as offal, of said animal species. In more recent times, the term ‘meat’ is more casually used in the sense of animal species in general, i.e. as including also avian and aquatic species. For ease of reference, in the context of this invention, the edible parts of (land) animals, fish, poultry crustaceans and shellfish are all referred to as ‘(animal) meat’. This means that, for example, the term ‘poultry meat’ refers to the edible tissue of poultry and, as such, these terms can be interchanged without changing the scope of the invention in any way. The term ‘fish meat’ similarly refers to (and is interchangeable with) the edible tissue of fish, etc. Hence, in accordance with the invention, the meat can be obtained from any species generally used in the food industry, including livestock species such as cattle (beef), pigs (porc), sheep/lamb, deer, etc.; avian species such as chicken, turkey, etc.; and aquatic species such as salmon, catfish, trout, flounder, haddock, cod, mackerel, tuna, swordfish, shark, etc.

In the art, a distinction is usually made between processed and non-processed meat products. The term ‘processed meat’ typically is used to refer to meat products, the preparation of which involves processing steps in addition to merely skinning the carcass, dismembering the carcass and/or boning of the meat. Processed meat and poultry products are a very broad category of many different types of products all defined by having undergone at least one further processing or preparation step such as grinding, adding an ingredient, subjecting to heat-treatment, smoking, fermenting, drying, etc. Such treatment significantly change the appearance, texture and/or taste of the meat. According to a preferred embodiment of the invention, the meat product (to be) treated with the meat treatment compositions of the invention is a fresh or non-processed meat product, preferably a fresh or non-processed meat product selected from the group consisting of (skinned) animal carcasses, animal carcass parts and fresh or raw meat cuttings or trimmings, such as the primal cuts or the subprimal cuts. According to a preferred embodiment of the invention, the meat product (to be) treated with the meat treatment compositions of the invention is a (skinned) animal carcasses and animal carcass parts.

As will be understood by those skilled in the art, (muscle) meat surfaces can typically be categorized as either “fat side”, containing appreciable quantities of adipose tissue, or “lean surface”, which is substantially free of adipose tissue, depending on where from the carcass it originates. Although the present inventors have established that the meat treatment compositions can advantageously be used for the treatment of either surface, the effectiveness may differ depending on the type of surface, due to the presence or absence of adipose tissue and the way the preservative components interact with the tissues. Hence, embodiments are envisaged where the methods of the invention comprise the treatment of the lean side or lean surface of a meat product as defined herein. Alternatively, embodiments are envisaged where the methods of the invention comprise the treatment of the fat side or fat surface of a meat product as defined herein.

An aspect of the invention is directed to the meat products obtainable by the methods of this invention. The meat products benefit from the treatment with the meat treatment compositions as defined herein, in that it reduces the counts of potentially pathogenic bacteria on the surface thereof, aiding to food-safety and shelf-life of the meat product.

Another aspect of the invention concerns the use of the combination of the nonionic surfactant, organic acid and other optional components, preferably in the form of the meat treatment compositions as defined herein, for reducing bacteria counts on the surface of a meat product.

Another aspect of the invention concerns the use of the combination of the nonionic surfactant of the invention, organic acid, and other optional components, preferably in the form of the meat treatment compositions as defined herein, for use as a meat surface treatment agent and/or for use in surface treatment in meat processing.

In a preferred aspect the bacteriocidal effects are in respect of bacteria known to contaminate meat surfaces during the slaughtering of animals and/or the skinning and deboning of animal carcasses, as defined herein elsewhere. In a particularly preferred embodiment of the invention, the bactericiodal effect is in respect of at least two, most preferably at least three of the species of bacteria defined herein.

The details and preferred embodiments of these aspects of the invention will be readily understood by those skilled in the art based on the foregoing detailed descriptions of the meat treatment composition.

Thus, the invention has been described by reference to certain embodiments discussed above. It will be recognized that these embodiments are susceptible to various modifications and alternative forms well known to those of skill in the art.

Many modifications in addition to those described above may be made to the structures and techniques described herein without departing from the spirit and scope of the invention. Accordingly, although specific embodiments have been described, these are examples only and are not limiting upon the scope of the invention.

Furthermore, for a proper understanding of this document and in its claims, it is to be understood that the verb “to comprise” and its conjugations is used in its non-limiting sense to mean that items following the word are included, but items not specifically mentioned are not excluded. In addition, reference to an element by the indefinite article “a” or “an” does not exclude the possibility that more than one of the element is present, unless the context clearly requires that there be one and only one of the elements. The indefinite article “a” or “an” thus usually means “at least one”.

All patent and literature references cited in the present specification are hereby incorporated by reference in their entirety.

The following examples are offered for illustrative purposes only, and are not intended to limit the scope of the present invention in any way.

### EXAMPLES

### Example 1: Antimicrobial Effectiveness of Antimicrobial Solutions Applied to Cuts of Beef Brisket Sub-Primal

The objective of this experiment was to determine the log reductions achieved in lab scale experiment and validate the antimicrobial effectiveness of antimicrobial solutions applied to cuts of beef brisket sub-primal to reduce STEC contamination.

### Experimental Setup

Antimicrobial efficacy of different compositions according to the inventions and disclosures described herein has been tested in the form of a ready to use solution and compared to the antimicrobial performance of a 5% lactic acid solution. Water treatment was used as a control. Experiments were done on 0.7 kg cuts of beef brisket sub-primal. Each brisket has two sides: a fat side with adipose tissue and a lean side with no adipose tissue. Each piece was trimmed for any surface fat from the lean side to get a uniform fat and lean side. All brisket pieces were kept at 55° C. for approximately 3 hours until a 34-37° C. surface temperature is reached, in order to reflect freshly slaughtered hot carcass surface. All brisket subprimals were spray inoculated with a 7-strain (O157:H7, O26, O45, O103, O111, O121, and O145) rifampicin-resistant Shiga toxin producing E. Coli (STEC) cocktail on each side independently (fat and lean side) and allowed to attach for 30 min. at 37° C. At this point, a 42.45 cm² sample was taken from the lean and fat side, later referred to as “post-inoculation sample”, and processed as described below.

Subsequently, the antimicrobial treatment or control was sprayed onto each of the two sides (fat and lean) of the brisket sub-primal surface with uniform application of treatment volume per side, applying 7 mL per side of the brisket subprimal. After 10 min contact time, a 42.45 cm² sample was taken from the lean and fat side, later referred to as “post-treatment spray sample”, and processed as described below.

Subsequently, each the beef brisket sub-primal was vacuum packaged and stored for 24-hours at 4° C. At this point, a 42.45 cm² sample was taken from the lean and fat side, later referred to as “post-24 h chill sample”, and processed as described below.

### Sample Processing

Immediately after sampling, the sample is combined in a stomacher bag with 75 ml 0.1% D/E (Dey/Engley) neutralizing broth (to inactivate any residual activity of antimicrobial treatments) and stomached for 1 min. Samples were serially diluted using 0.1% peptone water and plated onto tryptic soy agar (TSA) supplemented with 0.1 g/L rifampicin.

### Results

The antimicrobial performance results are represented as Log CFU/cm² in terms of log reductions, as compared to the post-inoculation sample. Values >0 indicate a reduction in the bacterial counts, and thus an increase in antimicrobial performance. Values <0 indicate an increase in the bacterial counts, and thus a decrease in antimicrobial performance. Performance over benchmark is calculated as “<formulation performance>- <benchmark performance>”. Values >0 indicate an increase in antimicrobial performance of the formulation compared to the benchmark. Values <0 indicate a decrease in antimicrobial performance of the formulation compared to the benchmark.

The results are summarized in table 1 below. As will be obvious from the data presented in this table, the formulations according to the invention provide improved antimicrobial performance compared to a 5% lactic acid benchmark. More in particular, the 5% lactic acid, 0.1% Caprol PGE860 solution according to the invention provides improved lean and fat side antimicrobial activity for both the post-treatment spray sample compared to the benchmark.

TABLE 1

| | | | | | Post- | | | |
|---|---|---|---|---|---|---|---|---|
| | | | | | treatment | | Post-24 h | |
| | | | | | spray | | chill | |
| | Post- | | | | sample - | | sample - | |
| | treatment | | Post-24 h | | performance | | performance | |
| | spray | | chill | | over | | over | |
| | sample | | sample | | benchmark | | benchmark | |
| | Lean | Fat | Lean | Fat | Lean | Fat | Lean | Fat |
| Log CFU/cm² | Side | Side | Side | Side | Side | Side | Side | Side |
| Deionized | −0.86 | 0.00 | −0.81 | −0.36 | — | — | — | — |
| water | | | | | | | | |
| (Control) | | | | | | | | |
| 5% lactic acid | 0.38 | 0.44 | 0.34 | 1.60 | — | — | — | — |
| (Benchmark) | | | | | | | | |
| 5% lactic acid | 0.63 | 1.30 | 0.94 | 1.02 | 0.25 | 0.86 | 0.61 | −0.59 |
| 0.1% Caprol | | | | | | | | |
| PGE 860 | | | | | | | | |
| (polyglycerol | | | | | | | | |
| ester) | | | | | | | | |

### Example 2: Antimicrobial Effectiveness of Antimicrobial Solutions Applied to Pre-Rigor Beef Carcass Sides

The objective of this experiment was to determine the log reductions achieved in lab scale experiment and validate the antimicrobial effectiveness of antimicrobial solutions applied to pre-rigor beef carcass sides using a three-stage commercial spray cabinet (Chad Equipment) to reduce STEC contamination.

### Experimental Design:

Finished beef cattle (450-500 kg after dressing) were obtained at the Kansas State University (KSU) Biosecurity Research Institute (BRI) holding unit from a local feedlot. USDA-approved methods were utilized for slaughtering each animal, within 6 h of arrival at the facility and immediately used for research. Common commercial slaughter protocol was used which had steps such as steam vacuuming of the dressed carcass along hide opening lines (pattern lines) and the midline after mechanical hide removal. Two beef cattle were slaughtered on each three different days (replications) for a total of 6 animals or 12 carcass sides. Each set of replication required a fresh STEC inoculum cocktails and antimicrobial solutions and were prepared the respective day. All research experiments were carried out at the KSU BRI, a biosafety level-3 biocontainment laboratory having full-scale slaughter and meat fabrication capabilities.

### Bacterial Cultures and Inoculum Preparation:

Rifampicin-resistant derivatives of E. coli O157:H7 (ATCC 31150; human isolate) and non-O157 STEC serogroups O26 (H30, human isolate), O45 (CDC 96-3282, human isolate), O103 (CDC 90-3128, human isolate), O111 (JB1-95, clinical isolate), O121 (CDC 97-3068, human isolate), and O145 (83-75, human isolate) were used to inoculate carcass sides. Strains were propagated in 10 ml sterile tryptic soy broth (TSB; Difco Laboratories, Detroit, Mich. ) supplemented with 0.1 g/L rifampicin (TSBrif); Tokyo Chemical Industry, Tokyo, Japan) with incubation at 37° C. for 24 h. A loop of each of these solutions was transferred to tubes containing 10 ml TSBrif and incubated at 37° C. for 24 h. Subsequently, a loop of these seven solutions was transferred into centrifuge bottles containing 225 ml TSBrif and incubated at 37° C. for 24 h. Each of the 7 bottles were then centrifuged for 15 min at −4° C. and 4960×g and the supernatant decanted. Each bacterial pellet was reconstituted with 10 ml 0.1% peptone water (Dlfco) and combined to make 70 ml of a 7-serogroup inoculum mixture. This STEC cocktail was diluted with 0.1% peptone water to reach a final volume of 10 L (at ˜6.0 log CFU/ml) immediately prior to use as the inoculum solution.

### Application of Inoculum

A hand applicator system consisting of brush was utilized to manually apply and deliver a total of 200 ml of solution to uniformly cover the entire exposed surface area of the carcass (established in preliminary trials). Carcass sides were individually inoculated with the STEC cocktail inoculum (200 ml) (4 in total for each replications). After inoculum application, carcass sides were undisturbed for 30-min (STEC attachment period) before starting the treatment in the CHAD the cabinet. The target STEC inoculation level was ˜7 log CFU/100 cm2. Once carcasses were inoculated, a long rod was used to contact only the roller trolley hook to move carcasses along the rail to the Chad carcass wash cabinet without touching any of the inoculated carcass surfaces.

### Antimicrobial Preparation

Solutions of antimicrobials (5% L-lactic acid; and 5% lactic acid 0.1% Caprol PGE 860; all from Corbion, Lenexa, Kans.), were all prepared according to manufacturers' recommendations. Lactic acid 88% is a concentrated mixture of lactic acid in water. Concentrations of lactic acid in each solution was confirmed by titrating 5 ml of the solution with 0.25 N NaOH (Fisher Scientific) using 1% phenolphthalein (Fisher Scientific) as an indicator. Fresh antimicrobial solutions were prepared from the original stock concentrates for each experimental replication.

### Application of Treatments:

Experimental replications consisted of four carcass sides sequentially receiving treatments using a three-stage commercial spray cabinet (Chad Equipment, Olathe, Kans.) following the 30-min inoculum attachment period. Only two stages were activated for this experiment—ambient wash section and antimicrobial spray section; hot water wash section was not utilized. After each stage of the Chad cabinet, the long rod was used to pull the carcass side back out of the cabinet for sample collection (as defined in the next section). After each sample collection, the carcass side was returned to the next stage of the cabinet to resume sequential washing scenarios. In stage 1, an ambient high volume water wash (˜23° C. for 15 s) was applied to carcass sides via ninety-four ⅛″ MEG 2510 nozzles (Chad Equipment) at 250 psi. Stage 2 utilizing a hot water wash (82-92° C. for 12 s) applied using forty-four H ⅜″ U 5050 nozzles (Chad Equipment) at 15 psi was not used. Thus, all carcass sides received the same ambient water washes (stages 1) of the sequential treatment scenarios. As a final treatment (stage 3), each carcass side was randomly assigned one of three chemical spray treatments: control (no antimicrobial treatment), lactic acid, and 5% lactic acid 0.1% Caprol PGE 860. Antimicrobial treatments were applied as a mist (40 psi) for 12 sec using ten H1/8VVSS110015 nozzles (Chad Equipment). All antimicrobial treatments were applied at 55° C. (at nozzle).

### Microbial Sampling

Three sampling points were used during processing to determine rifampicin-resistant STEC populations on carcass sides: post-inoculation (to get the inoculation counts), post-ambient water treatment (stage 1), post-antimicrobial chemical treatment (stage 3). Three specific anatomical locations, being the top (round), middle (flank), and bottom (neck/brisket) of the carcass side, were sampled at each processing point. Excised tissue samples were obtained by removing 42.25 cm² surface areas from each anatomical location at each sampling point using a sterile corer, scalpel, and forceps. Cored samples were placed into a sterile filter-style Whirl-Pak bag (Nasco, Fort Atkinson, Wis.) containing 75 ml Dey-Engley neutralizing broth (Difco) supplemented with 0.1 g/L rifampicin and stomached for 1 min in an AES smasher (Biomerieux, Macry-I'Etoile, France). Each sample was serially diluted in 0.1% peptone water supplemented with 0.1 g/L rifampicin and subsequently plated in duplicate on APC Petrifilm (3M, St. Paul, Minn.). Petrifilm plates were incubated at 37° C. for 24 h and counted in compliance with manufacturer's instructions.

### Results

The results are summarized in the following table 2. As can be inferred from the table, the 5% lactic acid 0.1% Caprol PGE 860 treatment resulted in a substantial reduction of STEC on the carcass, compared to control and compared to the treatment with lactic acid alone.

TABLE 2
Log CFU/100 cm² reductions

| | STEC Beef Carcass Log | | |
|---|---|---|---|
| | Reductions | | |
| | Log CFU/100 cm2 Units | | |
| Treatments | Top | Middle | Bottom |
| Water | 0.30 | 0.28 | 0.19 |
| 5% lactic acid | 0.97 | 0.89 | 0.81 |
| 5% lactic acid 0.1% Caprol PGE 860 | 2.39 | 2.34 | 2.12 |

What is claimed is:

1. A meat treatment composition, comprising:
(i) a nonionic surfactant, selected from the group consisting of polyglycerol fatty acid esters; and
(ii) an organic acid selected from the group consisting of C₂-C₈ monocarboxylic acids, lactic acid, citric acid, and mixtures thereof.

2. The meat treatment composition according to claim 1, wherein the nonionic surfactant is decaglycerol mono/dioleate (Caprol PGE 860).

3. The meat treatment composition according to claim 1, wherein the organic acid is lactic acid.

4. The meat treatment composition according to claim 1, wherein the meat treatment composition further comprises (iii) a thickening agent.

5. The meat treatment composition according to claim 4, wherein the thickening agent is selected from the group consisting of xanthan, carrageenan and alginates.

6. The meat treatment composition according to claim 1, wherein the organic acid and the nonionic surfactant are present in a weight ratio within 300/1-10/1.

7. The meat treatment composition according to claim 1, wherein the organic acid and the nonionic surfactant are present in a weight ratio within 250/1-20/1.

8. The meat treatment composition according to claim 6, having a pH value of below 6.

9. The meat treatment composition according to claim 4, wherein the organic acid and the thickening agent are present in a weight ratio within 200/1-20/1.

10. The meat treatment composition according to claim 4, wherein the organic acid and the thickening agent are present in a weight ratio within 150/1-40/1.

11. The meat treatment composition according to claim 4, which is in the form of a concentrate, comprising the non-ionic surfactant in amount of 0.2-2.5 wt. %, based on the total weight of the concentrate; the organic acid in an amount of 20-95 wt. %, based on the total weight of the concentrate; and/or the optional thickening agent in an amount of 0.2-2.5 wt. %, based on the total weight of the concentrate.

12. The meat treatment composition according to claim 4, which is in the form of a ready-to-use liquid, comprising the non-ionic surfactant, the organic acid, and the optional thickening agent in a combined amount of at least 0.5 wt. %, based on the total weight of the liquid.

13. The meat treatment composition according claim 4, which is in the form of a ready-to-use liquid, comprising the non-ionic surfactant in an amount of 0.01-0.5 wt. %, based on the total weight of the liquid; the organic acid in an amount of 1-20 wt. %, based on the total weight of the liquid; and/or the optional thickening agent in an amount of 0.01-0.5 wt. %, based on the total weight of the liquid.

14. The meat treatment composition according to claim 4, which is in the form of a ready-to-use liquid, comprising the non-ionic surfactant in an amount of 0.02-0.25, based on the total weight of the liquid; the organic acid in an amount of 1.5-10 wt. %, based on the total weight of the liquid; and/or the thickening agent in an amount of 0.02-0.25 wt. %, based on the total weight of the liquid.

15. A method of reducing microbial and/or bacterial counts on a surface of an animal meat product, comprising contacting the meat surface with a liquid meat treatment composition, comprising:
(i) a nonionic surfactant selected from the group consisting of polyethoxylated sorbitan fatty acid esters;
(ii) an organic acid selected from the group consisting of C₂-C₈ monocarboxylic acids, lactic acid, citric acid, and mixtures thereof; and optionally,
(iii) a thickening agent,
wherein the non-ionic surfactant, the organic acid, and the optional thickening agent are present in a combined amount of at least 0.5 wt. %, based on the total weight of the liquid.

16. The method according to claim 15, wherein the animal meat product is selected from the group consisting of animal carcasses, animal carcass parts, fresh or raw cut meat pieces and raw processed meat products.

17. The method according to claim 15, wherein the contacting is by spraying or dipping.

18. The method according to claim 15, comprising the consecutive steps of:
(a) contacting the meat product with water;
(b) contacting the meat product with the meat treatment composition;
(c) rinsing the meat product with water.

19. The method according to claim 15, wherein the bacteria are pathogenic species of bacteria from the group consisting of Shiga toxin producing Escherichia coli (STEC) O157:H7, O26, O45, O103, O111, O121, and O145.

20. A kit of parts, comprising:
(a) two or more separate containers,
wherein a first container comprises a quantity of organic acid, optionally in combination with a quantity of (i) non-ionic surfactant and (ii) optional thickening agent, and
wherein a second container comprises a quantity of one or both of (i) the non-ionic surfactant and (ii) the thickening agent, and optionally,
(b) a label or leaflet with instructions for use, the use comprising combining the components held in the containers included in the kit-of-parts, optionally adding a quantity of water and applying the liquid accordingly obtained to an animal meat surface.
